(19) United States
(12) Patent Application Publication
(10) Pub. No.: US 2013/0182000 A1
(43) Pub. Date: Jul. 18, 2013

(54) SYSTEM AND METHOD FOR RENDERING AN IMAGE

(71) Applicant: Jang Hee Kim, Seoul (KR)

(72) Inventor: Jang Hee Kim, Seoul (KR)

(73) Assignee: MACROGRAPH CO., LTD., Seoul (KR)

(21) Appl. No.: 13/404,337

(22) Filed: Feb. 24, 2012

(30) Foreign Application Priority Data
Jan. 16, 2012 (KR) 10-2012-0004595

(51) Int. Cl. G09G 5/00

(52) U.S. Cl. 345/581

(57) ABSTRACT

An image rendering method includes receiving, by a central processing unit (CPU), a plurality of first primitives, dividing, by the CPU, each of the plurality of first primitives into each of a plurality of grids, collecting, by the CPU, the plurality of grids as a grid set, transmitting the grid set from the CPU to a graphic processing unit (GPU) when a size of the grid set is greater than a threshold value, and shading, by the GPU, the grid set.

### CROSS-REFERENCE TO RELATED APPLICATION

This application claims priority under 35 U.S.C. §119(a) to Korean Patent Application No. 10-2012-0004595 filed on Jan. 16, 2012, the entire contents of which are hereby incorporated by reference.

### BACKGROUND

Embodiments of the present inventive concepts relate to an image processing, and more particularly, to an image rendering system capable of rendering an image efficiently and a method thereof.

As expectations of a consumer who consumes an image medium such as a movie and an animation for the image medium is getting high, demands for the image medium having higher quality is growing. However, a lot of equipments, work force and time are needed to meet customer's demands requesting the image medium having the higher quality. Accordingly, a method for reducing rendering time of an image forming the image medium is required.

### SUMMARY

An embodiment of the present inventive concepts is directed to an image rendering method, including receiving, by a central processing unit (CPU), a plurality of first primitives, dividing, by the CPU, each of the plurality of first primitives into each of a plurality of grids, collecting, by the CPU, the plurality of grids as a grid set, transmitting the grid set from the CPU to a graphic processing unit (GPU) when a size of the grid set is greater than a threshold value, and shading, by the GPU, the grid set.

According to an example embodiment, the image rendering method may further include calculating, by the CPU, a size of the grid set and determining, by the CPU, if a size of the grid set is greater than the threshold value.

According to an example embodiment, the image rendering method may further include repeating, by the CPU, collection of the plurality of grids until the size of the grid set is greater than the threshold value. According to an example embodiment, the image rendering method may further include transmitting the shaded grid set from the GPU to the CPU after shading the grid set.

According to an example embodiment, the image rendering method may further include receiving, by the CPU, a plurality of second primitives while the GPU shades the grid set.

An example embodiment of the present inventive concepts is directed to an image rendering system, including a graphic processing unit (GPU) and a central processing unit (CPU).

The CPU includes a dicing module dividing each of a plurality of first primitives into each of a plurality of grids, a shading pool collecting the plurality of grids as a grid set and a data transmission module transmitting the grid set from the CPU to the GPU when a size of the grid set is greater than a threshold value.

The GPU includes a shading module shading the grid set. The shading pool repeats collecting the plurality of grids until the size of the grid set is greater than the threshold value.

The shading module transmits the shaded grid set from the GPU to the CPU after shading the grid set. The dicing module receives a plurality of second primitives while the GPU shades the grid set.

### BRIEF DESCRIPTION OF THE DRAWINGS

The above and other features and advantages of example embodiments will become more apparent by describing in detail example embodiments thereof with reference to the attached drawings in which:

FIG. 1 is a block diagram of an image rendering system according to an example embodiment of the present inventive concepts;

FIG. 2 is a diagram of a plurality of primitives according to an example embodiment of the present inventive concepts;

FIG. 3 is a diagram of grids of the plurality of primitives according to an example embodiment of the present inventive concepts; and

FIG. 4 is a flowchart for explaining an operation of the rendering system illustrated in FIG. 1.

### DETAILED DESCRIPTION

Example embodiments now will be described more fully hereinafter with reference to the accompanying drawings, in which example embodiments are shown. Example embodiments may, however, be embodied in many different forms and should not be construed as limited to the embodiments set forth herein. Rather, these example embodiments are provided so that this disclosure will be thorough and complete, and will fully convey the scope of example embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

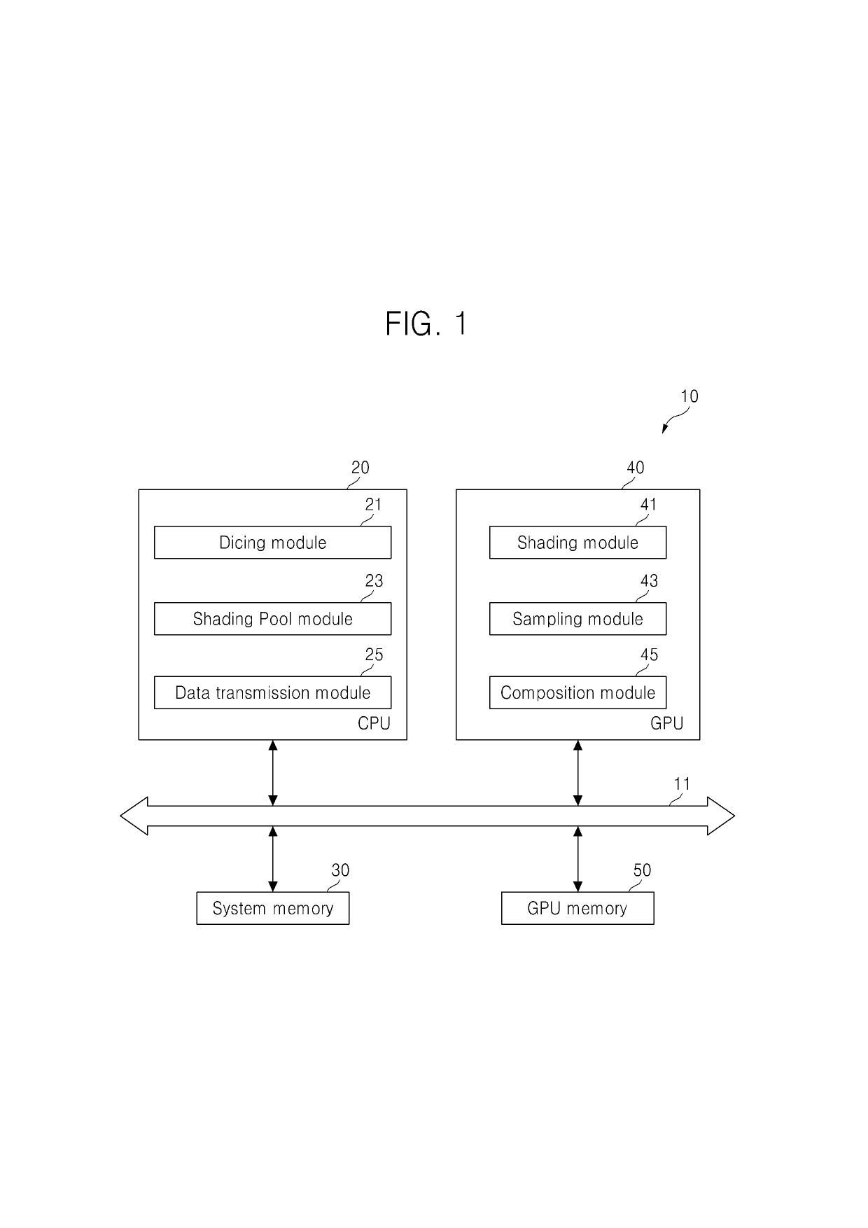

FIG. 1 is a block diagram of an image rendering system according to an example embodiment of the present inventive concepts.

Referring to FIG. 1, the image rendering system 10 processes various operations to generate an image. For example, the image rendering system 10 may be a computer, a tablet personal computer (PC) or a smart phone. The image rendering system 10 includes a central processing unit (CPU) 20, a system memory 30, a graphic processing unit (GPU) 40 and a GPU memory 50. The CPU 20, the system memory 30, the GPU 40 and the GPU memory 50 may communicate each other through a bus 11.

The CPU 20 includes a dicing module 21, a shading pool module 23 and a data transmission module 25.

A module of the present invention may mean a functional or a structural combination of hardware for performing technical concepts of the present invention and software for driving the hardware. For example, the module may mean a logical or a functional unit of a predetermined program code and a hardware resource for performing the program code, but may not mean a program code which should be connected physically or a kind of hardware.

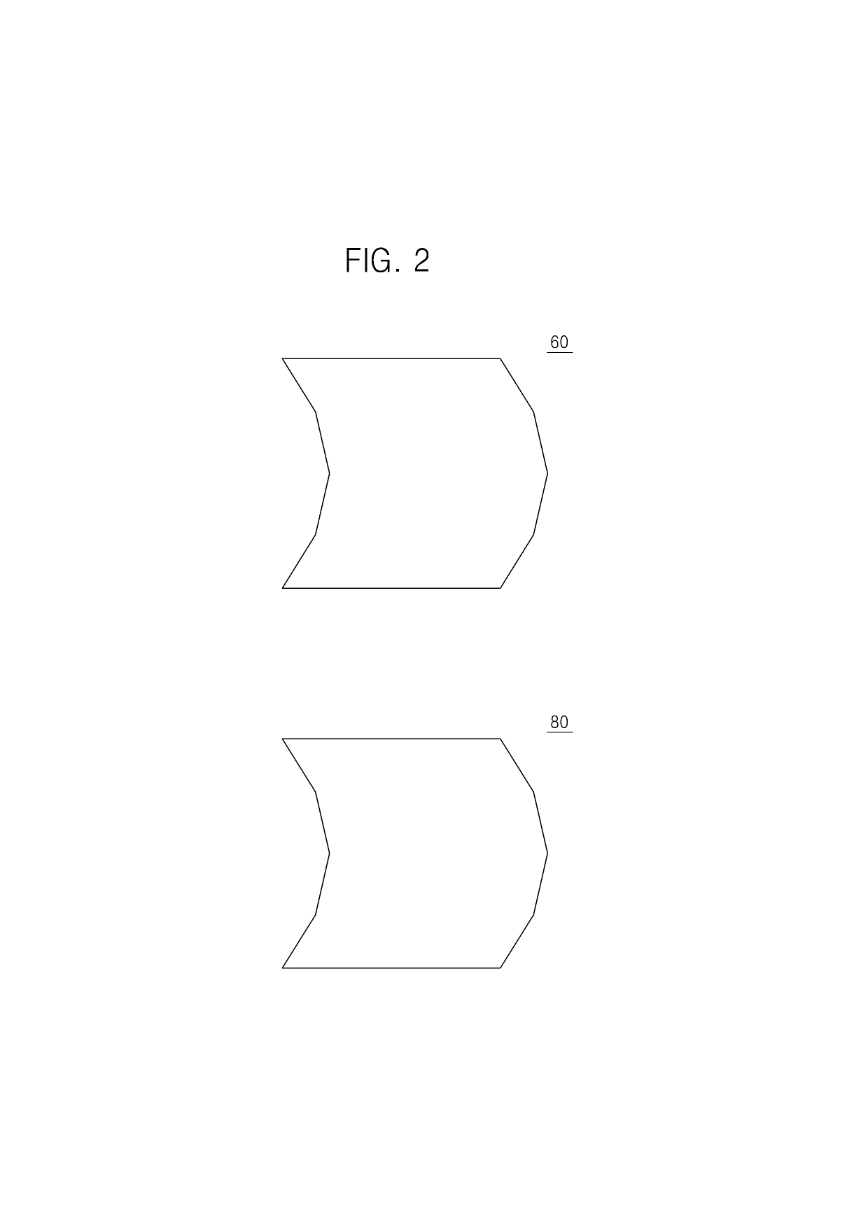

FIG. 2 is a diagram of a plurality of primitives according to an example embodiment of the present inventive concepts.

Referring to FIGS. 1 and 2, the dicing module 21 receives a plurality of primitives 60 and 80 from the system memory 30. The primitive 60 and 80 mean a simplest geometric object which may be processed in the image rendering system 10. The primitive 60 or 80 is illustrated by a square in FIG. 2; however, it may be a dot, a line, a plane, a triangle, a circle or a sphere.

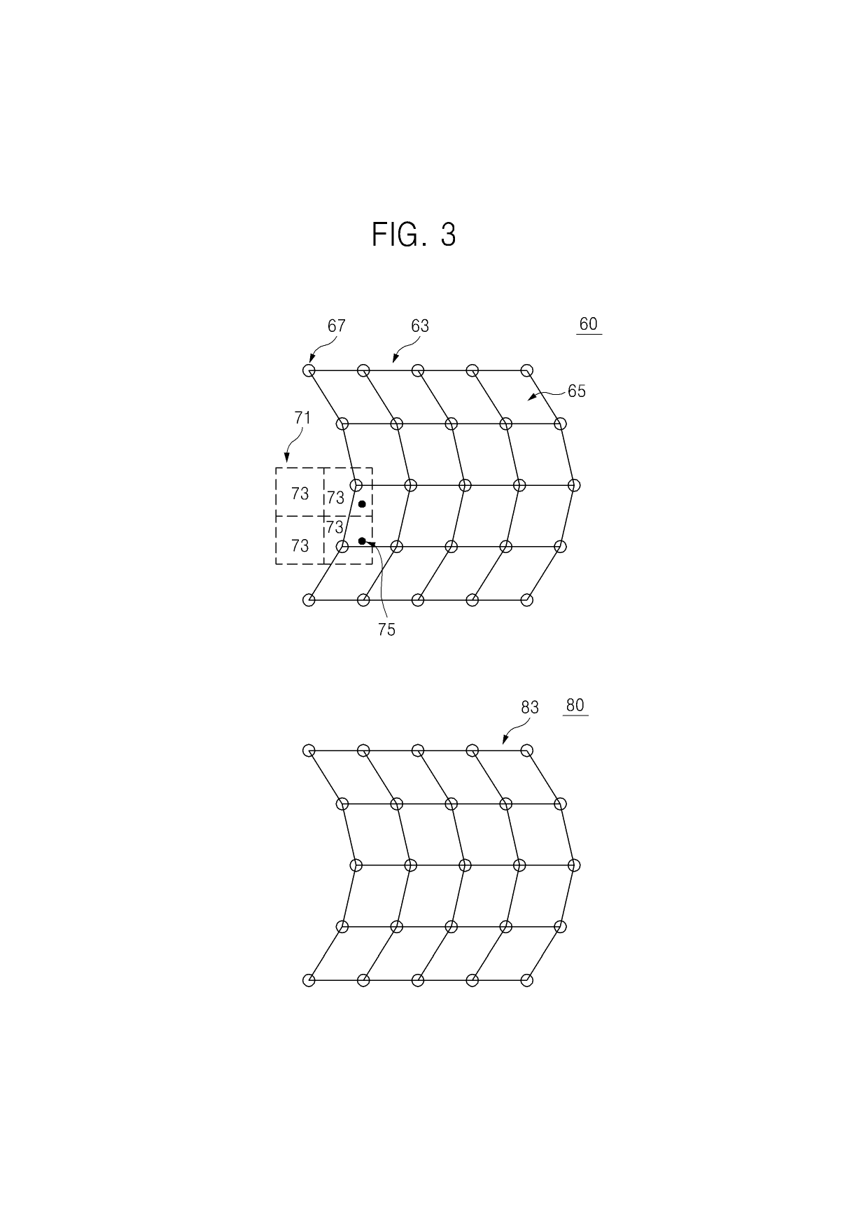

FIG. 3 is a diagram of grids of the plurality of primitives according to an example embodiment of the present inventive concepts.

Referring to FIGS. 1 and 3, the dicing module 21 divides each of the primitives 60 and 80 into each of grids 63 and 83. According to an example embodiment, the dicing module 21 may divide a primitive 60 or 80 into a plurality of grids.

The grid 63 includes a plurality of micro-polygons 65. Each micro-polygon 65 is illustrated by a quad in FIG. 2; however, it may be a tri-angle according to an example embodiment. A size of the micro-polygon 65 is similar to a size of a pixel 71. According to an example embodiment, the size of the micro-polygon 65 may be changed. For example the pixel 71 may include a plurality of micro-polygons 65 according to an example embodiment.

The shading pool module 23 collects a plurality of grids 63 and 83. By not transmitting each of the plurality of grids 63 and 83 to the GPU 40 immediately but collecting, by the shading pool module 23, the plurality of grids 63 and 83 as a grid set, performance of the GPU 40 gets improved. An idle state of the GPU 40 gets reduced when the GPU 40 processes the plurality of grids 63 and 83 at once rather than when the GPU 40 processes each of the plurality of grids 63 and 83 immediately.

The shading pool module 23 calculates a size of the grid set and determines if a size of the grid set is greater than a threshold value. The shading pool module 23 repeats collecting grids until the size of the grid set is greater than the threshold value. The shading pool module 23 transmits the grid set to the data transmission module 25 when the size of the grid set is greater than the threshold value.

The data transmission module 25 transmits the grid set, which is transmitted, to the GPU 40. After the data transmission module 25 transmits the grid set to the GPU 40, the CPU 20 performs a dicing operation by receiving other primitives from the system memory 30. That is, the CPU 20 performs various operations like a dicing operation while the GPU 40 performs an image processing operation.

The system memory 30 stores a plurality of primitives 60 and 80 and stores a program code performing an operation of each module 21, 23 and 25 of the CPU 20. In addition, the system memory 30 may store the grid set. The system memory 30 may be embodied in a volatile memory or a non-volatile memory.

The GPU 40 includes a shading module 41, a sampling module 43 and a composition module 45. The GPU 40 performs various operations for processing an image.

The shading module 41 performs a shading operation on a transmitted grid set. Accordingly, a location, a color and opacity of each vertex 67 are calculated. According to an example embodiment, the number of the vertex 67 may be changed. The shading module 41 performs a shading operation and transmits a shaded grid set to a sampling module 43 and the data transmission module 25.

The sampling module 43 samples sampling points 75 in the plurality of micro-polygons 65. A color, opacity and depth of the micro-polygon 65 on each of the sampling points 75 are interpolated and stored. A pixel 71 includes a plurality of sub pixels 73. The sub pixel 73 includes the sampling point 75.

The sampling module 43 is illustrated to be performed in the GPU 40 in FIG. 1; however the sampling module 43 may be performed in the CPU 20 according to an example embodiment. The composition module 45 composites together sampling points 75 to calculate a color, opacity and depth of the micro-polygon 65 on each of sampling points 75 interpolated by the sampling module 43. Accordingly, final pixel colors may be calculated by compositing the color and the opacity of the sampling points 75. According to an example embodiment, the composition module 45 may be performed in the CPU 20.

The GPU memory 50 stores a program code performing an operation of each module 41, 43 and 45 of the GPU 40. In addition, the GPU memory 50 may store the grid set transmitted from the data transmission module 20. The GPU memory 50 may be embodied in a volatile memory or a non-volatile memory. The GPU memory 50 and the system memory 30 are separated and illustrated in FIG. 1; however, the GPU memory 50 and the system memory 30 may be embodied as a memory according to an example embodiment.

According to an example embodiment, the image rendering system 10 may further include a display (not shown) for displaying an image.

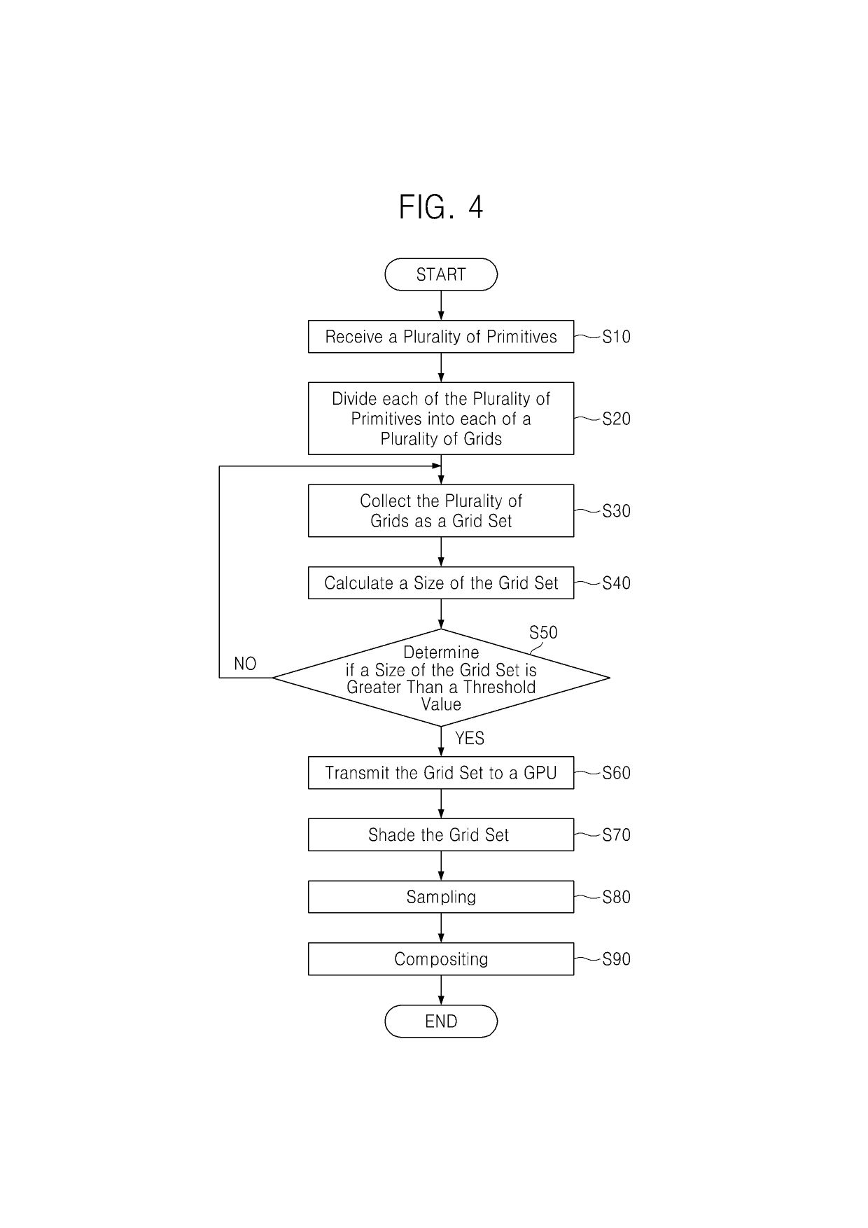

FIG. 4 is a flowchart for explaining an operation of the image rendering system illustrated in FIG. 1. Referring to FIGS. 1, 3 and 4, the CPU 20 receives a plurality of primitives 60 and 80 from the system memory 30 (S10). The dicing module 21 divides each of the plurality of primitives 60 and 80 into each of a plurality of grids 63 and 83 (S20).

The shading pool module 23 collects the plurality of grid 63 and 83 as a grid set (S30). The shading pool module 23 calculates a size of the grid set (S40). The shading pool module 23 determines if the size of the grid set is greater than a threshold value (S50). The shading pool module 23 repeats collecting grids when the size of the grid set is smaller than the threshold value. When the size of the grid set is greater than the threshold value, the shading pool module 23 transmits the grid set to the data transmission module 25. The data transmission module 25 transmits the grid set to the GPU 30 (S60).

A shading module 41 shades the grid set (S70). The sampling module 43 performs a sampling operation on the shaded grid set (S80). The composition module 45 composites the sampling points 75 (S90).

An image rendering system according to an example embodiment of the present inventive concepts and a method thereof may render an image efficiently by transmitting, by a central processing unit, a plurality of collected grids to a graphic processing unit.

While example embodiments have been particularly shown and described with reference to example embodiments thereof, it will be understood by those of ordinary skill in the art that various changes in forms and details may be made therein without departing from the spirit and scope of example embodiments as defined by the following claims..

What is claimed is:

1. An image rendering method comprising:
receiving, by a central processing unit (CPU), a plurality of first primitives;
dividing, by the CPU, each of the plurality of first primitives into each of a plurality of grids;
collecting, by the CPU, the plurality of grids as a grid set;
transmitting the grid set from the CPU to a graphic processing unit (GPU) when a size of the grid set is greater than a threshold value; and
shading, by the GPU, the grid set.

2. The method of claim 1, further comprising:
calculating, by the CPU, a size of the grid set; and
determining, by the CPU, if the size of the grid set is greater than the threshold value.

3. The method of claim 2, further comprising:
repeating, by the CPU, collection of the plurality of grids until the size of the grid set is greater than the threshold value.

4. The method of claim 1, further comprising:
transmitting the shaded grid set from the GPU to the CPU after shading the grid set.

5. The method of claim 1, further comprising:
receiving, by the CPU, a plurality of second primitives while the GPU shades the grid set.

6. An image rendering system comprising:
a graphic processing unit (GPU); and
a central processing unit (CPU) including a dicing module, which divides each of a plurality of first primitives into each of a plurality of grids, a shading pool, which collects the plurality of grids as a grid set, and a data transmission module, which transmits the grid set from a CPU to the GPU when a size of the grid set is greater than a threshold value,
wherein the GPU includes a shading module shading the grid set.

7. The system of claim 6, wherein the shading pool repeats collection of the plurality of grids until the size of the grid set is greater than the threshold value.

8. The system of claim 6, wherein the shading module transmits the shaded grid set from the GPU to the CPU after shading the grid set.

9. The system of claim 6, wherein the dicing module receives a plurality of second primitives while the GPU shades the grid set.
